(19) United States
(12) Patent Application Publication
(10) Pub. No.: US 2025/0366443 A1
(43) Pub. Date: Dec. 4, 2025

(54) PET LEASH DEVICE

(71) Applicant: Wenjie Xu, Wencheng County (CN)

(72) Inventor: Wenjie Xu, Wencheng County (CN)

(21) Appl. No.: 19/220,109

(22) Filed: May 28, 2025

(30) Foreign Application Priority Data
May 30, 2024 (CN) 202421213240.5

(51) Int. Cl. A01K 27/00

(52) U.S. Cl. CPC A01K 27/004; B65H 75/4431; B65H 75/486

(57) ABSTRACT

Disclosed is a pet leash device including a leash device body with a hand grip opening, in which an internal working cavity is formed. A leash opening is provided with a leash rope reel rotatably connected internally. The leash rope reel includes a first reel, a second reel, and a leash rope winding shaft connected therebetween. The leash rope winding shaft is provided with a placement groove opening outward, with an end of the placement groove penetrating the second reel to communicate with the exterior. An end of a leash steel rope is connected within the placement groove, while an opposite end extends outward through the leash opening. By replacing conventional leash ropes with a steel rope, the strength of the leash rope is enhanced, effectively preventing damage caused by pet biting.

### TE CROSS REFERENCE TO RELATED APPLICATIONS

The present disclosure claims the priority of Chinese Patent Application No. 202421213240.5 filed on May 30, 2024. All the above are hereby incorporated by reference in their entirety.

### TECHNICAL FIELD

The present disclosure relates to the field of leash devices, particularly to a pet leash device.

### BACKGROUND

To prevent pets from straying, owners commonly equip pets with leash devices. Current commercially available pet leash devices exhibit diverse structural configurations, typically including a housing, a rotating disk disposed within the housing, a leash rope coiled around the disk, and a rotary body arranged between the housing and disk for automatic leash retraction. Such conventional leash devices exhibit the following deficiencies: The employed leash ropes are fabricated from textile materials exhibiting insufficient tensile strength, rendering them prone to bite-induced fracture by pets, thereby resulting in limited service life. The connection structure between the leash rope reel and the leash rope terminal is oversimplified, proving incompatible with leash ropes of alternative materials, thus restricting applicability scope.

### SUMMARY

To solve the aforementioned problems, the present disclosure proposes a pet leash device that resolves: The problem of conventional leash ropes being fabricated from textile materials with insufficient tensile strength, which are prone to bite-induced fracture by pets, leading to limited service life; and the issue of restricted applicability scope caused by compatibility constraints between conventional leash rope reels and leash rope terminals.

The technical solution employed by the present disclosure is: A pet leash device includes a leash device body, in which a front end surface of the leash device body is provided with a hand grip opening penetrating front and rear sides, a working cavity is formed in an interior of the leash device body, an inner side wall of the working cavity is provided with a leash opening penetrating inner and outer sides, and a leash rope reel is rotatably connected to an inner side of the leash device body. The leash rope reel includes a first reel and a second reel, a leash rope winding shaft is connected between the first reel and the second reel, an outer surface of the leash rope winding shaft is provided with a placement groove opening outward, and an end of the placement groove penetrates the second reel to communicate with the exterior.

An end of the leash steel rope is connected to an inner side of the placement groove, the leash steel rope is wound around the leash rope winding shaft, and an opposite end of the leash steel rope extends outward from the leash opening.

### BRIEF DESCRIPTION OF THE DRAWINGS

In order to illustrate the technical solutions of the embodiments of the present disclosure or of the prior art more clearly, the following drawings are briefly described as required in the context of the embodiments or the prior art. Obviously, the following drawings illustrate only some of the embodiments of the present disclosure. Other relevant drawings may be obtained on the basis of the structure shown by these drawings without any creative effort by those skilled in the art.

FIG. 1 illustrates a complete structural diagram of the present disclosure;

FIG. 2 illustrates a cooperative state diagram between the leash rope reel and the working cavity of the present disclosure.

FIG. 3 illustrates an overall structural diagram of the leash rope reel of the present disclosure;

FIG. 4 illustrates another overall structural diagram of the leash rope reel of the present disclosure;

FIG. 5 illustrates an enlarged view of portion A in FIG. 4;

FIG. 6 illustrates a further overall structural diagram of the leash rope reel of the present disclosure.

The realization of objectives, functional characteristics, and advantages of the present disclosure will be further explained in conjunction with embodiments and with reference to the accompanying figures.

### DETAILED DESCRIPTION

The technical solutions in the embodiments of the present disclosure are clearly and completely described and discussed below in conjunction with the attached drawings of the embodiments of the present disclosure. Obviously, the embodiments described herein are only some of the embodiments of the present disclosure but not all of them. Based on the embodiments in the present disclosure, all other embodiments obtained by those skilled in the art without creative efforts fall within the scope of protection of the present disclosure.

It shall be expressly noted that all directional indicators (such as upper, lower, left, right, front, rear, etc.) in the embodiments of the present disclosure are solely intended to explain relative positional relationships and kinematic conditions among components under a specific orientation (as shown in the accompanying figures). Should said specific orientation be altered, these directional indicators shall correspondingly change in accordance with the modified orientation.

Additionally, the related terms such as “first”, and “second” are used for descriptive purposes only in the present disclosure and are not to be understood as indicating or implying relative importance or implicitly specifying the number of technical features indicated. As a result, a feature defined as “first” or “second” may expressly or implicitly include one or more such features. Additionally, the technical solutions of various embodiments may be mutually combined, provided that such combination is based on the capability of implementation by a person having ordinary skill in the art. Where the combination of technical solutions results in mutual contradictions or implementation impossibility, such combined technical solutions shall be deemed not to exist and fall outside the scope of protection claimed by the present disclosure.

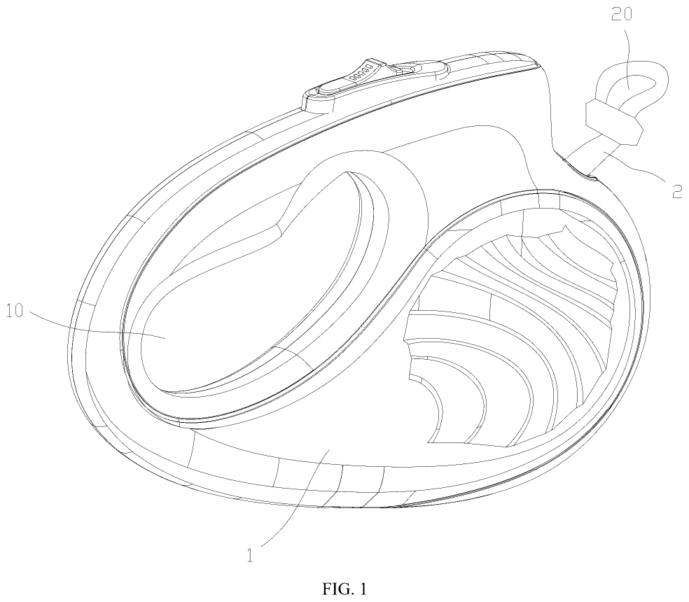

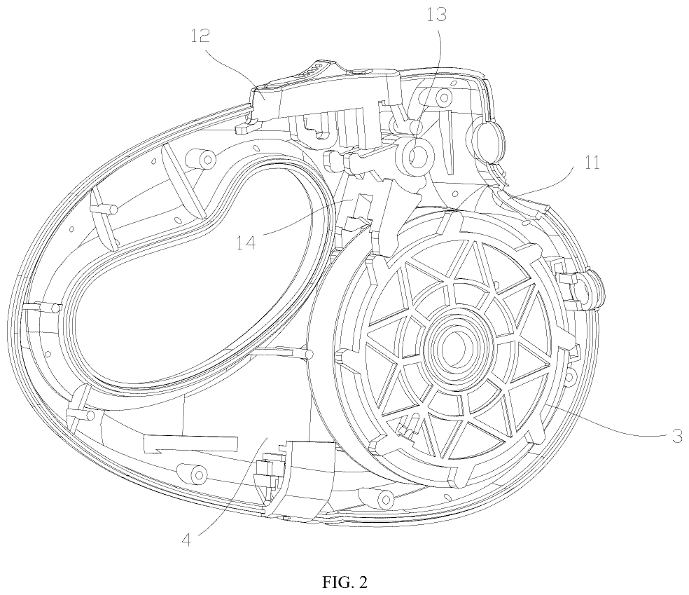

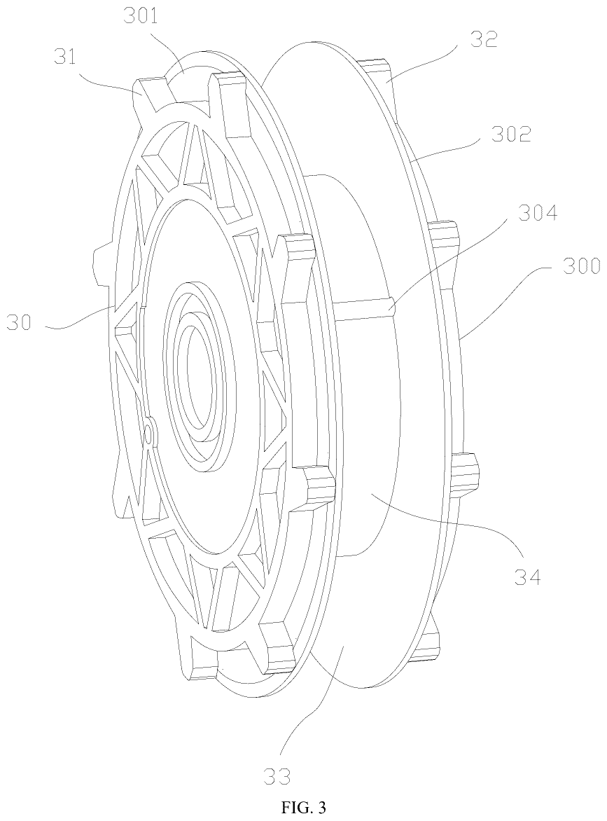

Referring to FIGS. 1 to 6, according to the present disclosure, a pet leash device includes a leash device body 1, in which a front end surface of the leash device body 1 is provided with a hand grip opening 10 penetrating front and rear sides, a working cavity 4 is formed in an interior of the leash device body 1, an inner side wall of the working cavity 4 is provided with a leash opening 11 penetrating inner and outer sides, and a leash rope reel 3 is rotatably connected to an inner side of the leash device body 1. The leash rope reel 3 includes a first reel 30 and a second reel 300, a leash rope winding shaft 34 is connected between the first reel 30 and the second reel 300, an outer surface of the leash rope winding shaft 34 is provided with a placement groove 304 opening outward, and an end of the placement groove 304 penetrates the second reel to communicate with the exterior. An end of the leash steel rope 2 is connected to an inner side of the placement groove 304, the leash steel rope 2 is wound around the leash rope winding shaft 34, and an opposite end of the leash steel rope 2 extends outward from the leash opening 11.

During use, the penetrating hand grip opening 10 formed on the leash device body 1 creates a gripping section between the hand grip opening 10 and the leash device body 1, facilitating user operation. Simultaneously, the working cavity 4 formed inside the leash device body 1 accommodates rotational movement of the leash rope reel 3, in which the leash rope reel 3 and the working cavity 4 are rotationally engaged through a rotating shaft and a rotational bore 37 for shaft positioning. Furthermore, a steel rope replaces conventional textile leash ropes to ensure stable fixation of the leash steel rope 2. The leash rope reel 3 is constructed with the first reel 30, the second reel 300, and the leash rope winding shaft 34 connected therebetween. The first reel 30 and the second reel 300 form a leash rope slot 33 for accommodating the leash rope. Moreover, the placement groove 304 formed on the leash rope winding shaft 34 extends to the exterior of the second reel 300 to receive a terminal of the leash steel rope 2. By placing the leash steel rope 2 into the placement groove 304 on the leash rope winding shaft 34 and subsequently winding it, the connection stability of the leash rope terminal is enhanced. The rotational positioning structure of the leash rope reel 3 within the working cavity 4 adopts conventional limiting mechanisms. The first reel 30 and second reel 300 are each provided with multiple sets of protruding limiting teeth 31, 32 circumferentially arranged on their mutually opposing side surfaces, forming limiting gaps 301, 302 between adjacent teeth. These gaps operably cooperate with a control button 12 disposed between leash openings 11 on the leash device body 1. Actuating the control button 12 drives a transition control member 13, which subsequently actuates a limiting member 14 to adjust the distance between the limiting member 14 and the limiting gaps 301, 302, thereby achieving rotational state control.

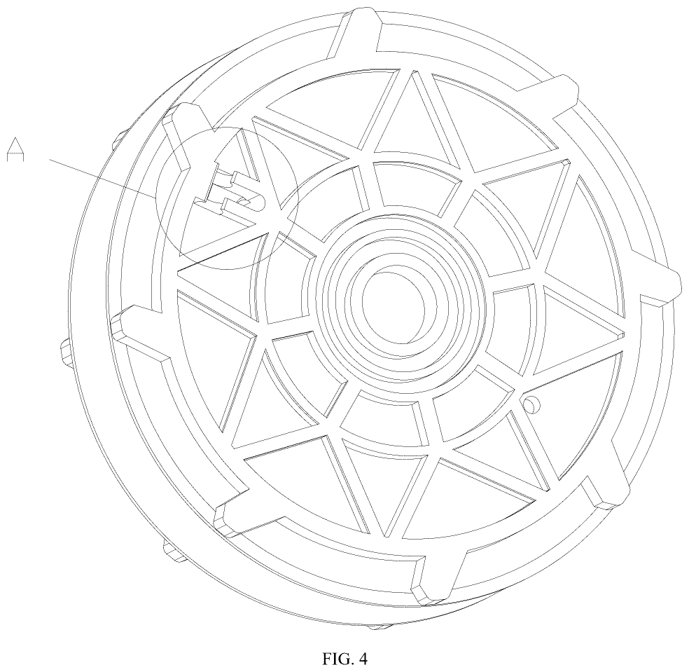

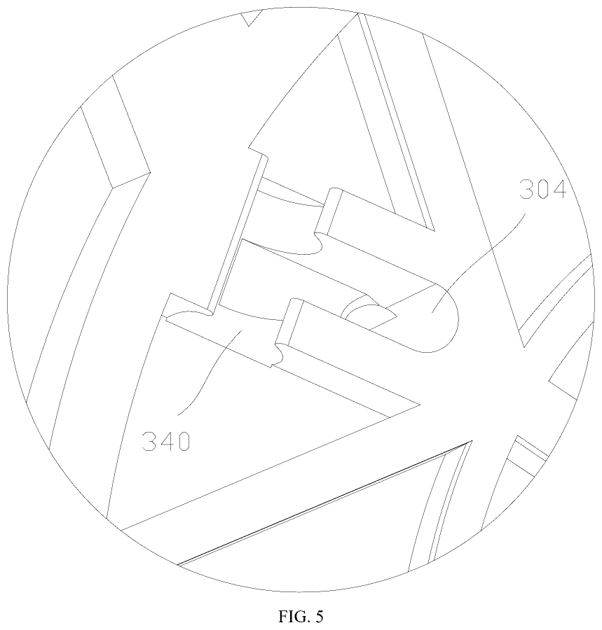

With reference to FIGS. 4-5, to ensure connection stability between the leash steel rope 2 and the leash rope reel 3, a fixation groove 340 opening outward is formed at the opening of the placement groove 304 on an end surface of the second reel 300 distal to the first reel 30. During use, a terminal of the leash steel rope 2 is placed into the fixation groove 340, where an externally mounted fixation block cooperates with the inner surface of the fixation groove 340 for fixation; alternatively, the terminal of the leash steel rope 2 is formed as a protrusion directly engaging with the inner surface of the fixation groove 340.

Specifically, a connection port 20 is formed at an end of the leash steel rope 2 outside the working cavity 4, which connects to an external buckle for enhanced attachment to a pet collar.

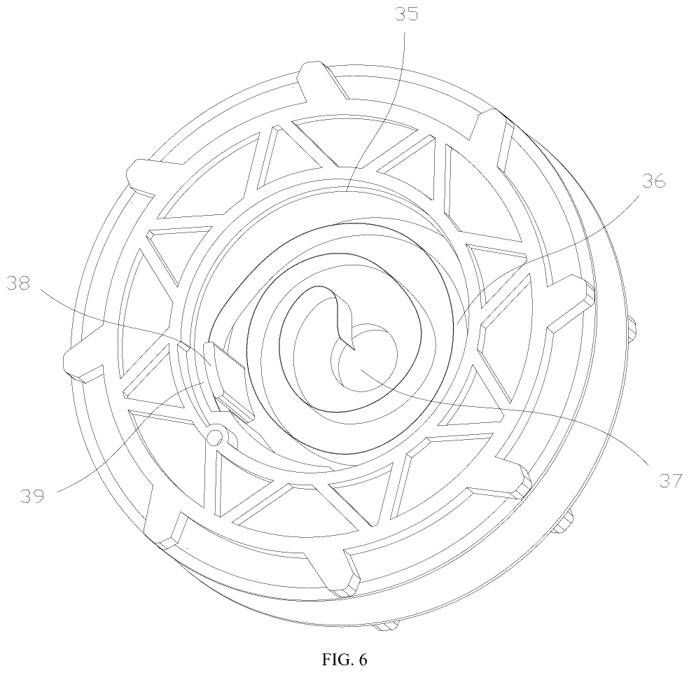

Referring to FIG. 6, specifically, a reset cavity 35 opening outward is provided at a central portion of an end surface of the first reel 30 distal to the second reel 300, and a reset spring plate 36 is disposed within the reset cavity 35. A protruding limiting post 38 is provided on a bottom wall of the reset cavity 35 adjacent to its edge, and a limiting port 39 is formed between the limiting post 38 and an inner side wall of the reset cavity 35. The first reel 30 is provided with a reset cavity 35 for accommodating a reset spring plate 36. An end of the reset spring plate 36 is directly connected to a rotating shaft disposed within the working cavity 4, with the reset spring plate 36 circumferentially arranged inside the reset cavity 35. An opposite end of the reset spring plate 36 is positioned within a limiting port 39 formed between a limiting post 38 and an inner side wall of the reset cavity 35. During leash steel rope 2 extension, the leash rope reel 3 initiates rotation, compressing the reset spring plate 36. Upon release of external constraints on the leash steel rope 2, the leash rope reel 3 becomes unrestrained, enabling the reset spring plate 36 to return to its initial position and effectuate leash steel rope 2 retraction.

In some implementations, a fixation groove opening outward is provided at the opening of the placement groove on an end surface of the second reel distal to the first reel.

In some implementations, an end of the leash steel rope located outside the working cavity 4 forms a connection port.

In some implementations, a reset cavity opening outward is provided at a central portion of an end surface of the first reel distal to the second reel, and a reset spring plate is disposed within the reset cavity.

In some implementations, a protruding limiting post is provided on a bottom wall of the reset cavity adjacent to its edge, and a limiting port is formed between the limiting post and an inner side wall of the reset cavity.

Compared with the prior art, the present disclosure provides the following advantageous effects: Implementation of a steel rope substitute for conventional leash ropes enhances tensile strength, effectively preventing bite-induced damage from pets. Simultaneously, the leash rope reel is constructed with the first reel, the second reel, and the leash rope winding shaft. The leash rope winding shaft is provided with a placement groove for securely connecting the terminal of the leash steel rope, effectively solving the connection instability of leash rope terminals in traditional leash reels.

The foregoing descriptions merely represent preferred embodiments of the present disclosure and shall not be construed as limiting the patent scope thereof. Any equivalent structural transformations made under the inventive concept of the present disclosure by using the contents of the specification and accompanying figures, whether directly or indirectly applied in other related technical fields, shall fall within the scope of patent protection of the present disclosure.

1. A pet leash device, comprising a leash device body, wherein a front end surface of the leash device body is provided with a hand grip opening penetrating front and rear sides, a working cavity is formed in an interior of the leash device body, an inner side wall of the working cavity is provided with a leash opening penetrating inner and outer sides, and a leash rope reel is rotatably connected to an inner side of the leash device body, characterized in that:
the leash rope reel comprises a first reel and a second reel, a leash rope winding shaft is connected between the first reel and the second reel, an outer surface of the leash rope winding shaft is provided with a placement groove opening outward, and an end of the placement groove penetrates the second reel to communicate with the exterior;
an end of the leash steel rope is connected to an inner side of the placement groove, the leash steel rope is wound around the leash rope winding shaft, and an opposite end of the leash steel rope extends outward from the leash opening.

2. The pet leash device according to claim 1, wherein a fixation groove opening outward is provided at the opening of the placement groove on an end surface of the second reel distal to the first reel.

3. The pet leash device according to claim 1, wherein an end of the leash steel rope located outside the working cavity forms a connection port.

4. The pet leash device according to claim 1, wherein a reset cavity opening outward is provided at a central portion of an end surface of the first reel distal to the second reel, and a reset spring plate is disposed within the reset cavity.

5. The pet leash device according to claim 4, wherein a protruding limiting post is provided on a bottom wall of the reset cavity adjacent to its edge, and a limiting port is formed between the limiting post and an inner side wall of the reset cavity.
